(19) United States
(12) Patent Application Publication
(10) Pub. No.: US 2011/0116259 A1
(43) Pub. Date: May 19, 2011

(54) CREATING AND MODIFYING A COLORED SHADOW

(76) Inventors: Eran Plonski, Montreal (CA); Sharath Kumar, Laval (CA); Eihab Baqui, Brossard (CA)

(21) Appl. No.: 12/818,321

(22) Filed: Jun. 18, 2010

Related U.S. Application Data
(63) Continuation of application No. PCT/CA2008/002239, filed on Dec. 19, 2008.
(60) Provisional application No. 61/015,091, filed on Dec. 19, 2007.

(51) Int. Cl. F21V 9/00

(52) U.S. Cl. 362/231

(57) ABSTRACT

There is described a lighting system for illumination of an object, comprising: a focusing light source for illuminating the object and creating a shadow of the object; and a background light source for illuminating a region comprising the shadow; and at least one LED emitting light, in one of the focusing light and the background light, of a given color in an appropriate quantity to color the shadow a target color.

### CROSS-REFERENCE TO RELATED APPLICATIONS

The present application is a continuation under 35 USC §120 of International patent application no. PCT/CA2008/002239 filed Dec. 19, 2008 entitled CREATING AND MODIFYING A COLORED SHADOW, which claims priority under 35 USC§119(e) of Provisional Patent Application bearing Ser. No. 61/015,091, filed on Dec. 19, 2007 entitled CREATING AND MODIFYING A COLORED SHADOW, the contents of which are hereby incorporated by reference.

### TECHNICAL FIELD

The present invention relates to the field of LED-based lighting systems.

### BACKGROUND

When an object is present in a room having different lighting systems, shadows of various colors may appear. The color of these shadows can be an issue in environments where the appearance of objects is of importance, such as retail stores. In retail stores, objects are usually illuminated by two different light sources: a background white light source and a focusing white light. While the purpose of the background white light is the illumination of the store, the focusing white light is used to display prominently the objects to be sold. However, the interaction between the shadow created by the focusing light and the background light can give rise to colored shadows that will affect the appearance of the displayed objects.

Shadows having a color different from dark or grey can be interesting for highlighting purposes, but the color of the shadow is dictated by the lights being used.

Therefore, there is a need for a method of creating or modifying a colored shadow.

### SUMMARY

According to a first broad aspect, there is provided a method for modifying a color of a shadow resulting from the interaction of a white light source and a colored light source illuminating an object, the method comprising: identifying a color of the shadow; determining a needed color, as a function of the color of the shadow, to modify the color of the shadow to a target color; and providing the needed color in the colored light source in a quantity appropriate to modify the color of the shadow to the target color.

According to a second broad aspect, there is provided a lighting system for illumination of an object, comprising: a focusing light source for illuminating the object and creating a shadow of the object; and a background light source for illuminating a region comprising the shadow; and at least one LED emitting light, in one of the focusing light and the background light, of a given color in an appropriate quantity to color the shadow a target color.

The expression “a colored LED” should be understood as “an LED emitting a colored light”. For example, a green LED is an LED emitting a green light.

The expression “light source” should be understood as any device, apparatus, system, etc, which emits light.

The expression “colored light source” refers to any lighting device which emits light having a color other than white, or white light of which the spectrum has at least one dominant component. An example of a colored light source is a white LED emitting white light having a dominant green spectral component caused by a phosphor coating.

The expression “white light source” refers to any lighting device which emits neutral white light in which all colors are present in substantially even proportion. The spectrum of a neutral white light has substantially no dominant component. A light source which is not a white light source is a colored light source.

### BRIEF DESCRIPTION OF THE DRAWINGS

Further features and advantages of the present invention will become apparent from the following detailed description, taken in combination with the appended drawings, in which:

FIG. 1 is a flow-chart for a method of reducing a colored shadow, in accordance with an embodiment of the present invention;

FIG. 2 is a flow-chart for a method of preventing a colored shadow according to one embodiment of the present invention;

FIG. 3 illustrates an example of a spectrum of a focusing light source having a dominant spectral component;

FIG. 4 is a flow-chart for a method of modifying a colored shadow according to one embodiment of the present invention;

FIG. 5 is a flow-chart for a method of creating a colored shadow according to one embodiment of the present invention; and

FIG. 6 illustrates a lighting system according to one embodiment of the present invention.

It will be noted that throughout the appended drawings, like features are identified by like reference numerals.

### DETAILED DESCRIPTION

Light-emitting diodes (LEDs) are presently used in lighting systems in replacement of conventional lighting technologies such as gas discharge lamps, incandescent bulbs and fluorescent lighting systems. White LEDs can be used in replacement of conventional lighting technologies to provide white light.

Alternatively, the light emitted by colored LEDs can be combined to create white light. One way of creating white light using colored LEDs is to combine the emitted light from red, green and blue (RGB) LEDs. LED lighting systems using this principle for creating white light are known as RGB-LED lighting sources. Another way of creating white light is to combine the emitted light from yellow and blue LEDs.

It should be understood that any LEDs or combination of LEDs for which the emitted light corresponds to a white light can be used with the method and system described herein. The expression “white light LED source” is used to refer to a light system or device using LEDs to create white light. The LEDs can be white LEDS or the LEDs can emit different colored lights that result in a substantially white light when mixed. The expression “colored LED” is used to describe an LED which emits light of a color different from white. Green, blue, red and yellow LEDs which emit green, blue, red and yellow light, respectively, are examples of colored LEDs.

In retail stores, objects located on a display unit are usually illuminated by two different light sources: a focusing light used to display prominently an object to be sold and a white background light used to illuminate the display unit. The focusing light creates a shadow of the object on the display unit. The shadow of the object can appear colored and the color of this shadow can be an issue. For example, the shadow can appear green when a magenta shadow is wanted. Alternatively, no colored shadow may be desired.

It should be understood that the expression “colored shadow” refers to shadows having a color different from neutral colors such as white, dark, grey and black. Red, yellow, magenta shadows are examples of colored shadows. When a shadow appears as a neutral color, this shadow is not a colored shadow.

When a white light source is used for background illumination, colored shadows of objects can appear if the shadow is created by a focusing light which is colored or has a dominant spectral component. The colored shadow appears as the complementary color of the color corresponding to the dominant spectral component.

Alternatively, a colored shadow can be observed when an object is illuminated by a focusing white light and when the region surrounding the shadow is illuminated by a background light which is colored or has a dominant spectral component. The colored shadow appears as the color corresponding to the dominant spectral component.

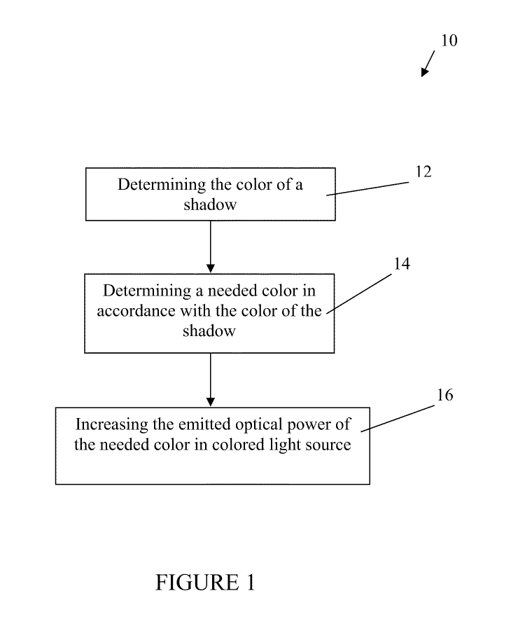

FIG. 1 illustrates one embodiment of a method 10 for reducing or eliminating a colored shadow created by a focusing light source and illuminated by a background light source. The first step 12 of the method 10 is the determination of the color of the shadow. The second step 14 is the determination of a color needed for eliminating the colored shadow in accordance with the color of the colored shadow. The last step 16 consists in providing the needed color, in a colored light source, in a quantity appropriate to reduce or substantially eliminate the colored shadow.

In one embodiment, the colored shadow is created by a focusing white light and illuminated by a colored background light. In this case, the needed color is the complementary of the color of the shadow and the optical power of the complementary color in the background light source is increased in a quantity appropriate to substantially eliminate the colored shadow.

In one embodiment, where the background light source creates light using colored LEDs and where light of the complementary color can be achieved using the colored LEDs, complementary color LEDs are driven under higher electrical conditions and a higher optical power is achieved. Complementary color LEDs are the colored LEDS which emit, alone or in combination, a light of the complementary color. Alternatively, at least one complementary color LED can be added in the background light system and is driven under electrical conditions appropriate to reduce or eliminate the colored shadow.

In another embodiment, where the background light source creates white light using white LEDs or where it creates white light using colored LEDs and the complementary color cannot be achieved using the colored LEDs, at least one colored LED emitting the required color can be used. Alternatively, colored LEDs emitting different colored lights for which the mixing results in the desired color light may be added to the background white light system.

In a further embodiment in which the background light source is a non-LED light device, at least one colored LED emitting the required color is added in the background non-LED light device and driven under appropriate electrical conditions in order to substantially remove the colored shadow.

In an RGB-LED background light source, if the color of the shadow is green, the optical power of the complementary color, namely magenta, is increased. Magenta is obtained by combining two primary colors, namely red and blue. By driving the red and blue LEDs under higher electrical conditions than the green LEDs in the RGB-LED background light source, the optical power of the magenta light is increased and the colored shadow is neutralized. Alternatively, if the shadow appears magenta, the green LEDS are driven under higher electrical conditions to neutralize the colored shadow.

In a background LED light source using blue and yellow LEDs to create white light, if the color of the shadow is blue, the optical power of the complementary color, namely yellow, is increased. By driving the yellow LEDs under higher electrical conditions than the blue LEDs, the colored shadow is neutralized.

In another embodiment, adding complementary color LEDs to the background light LED source will increase the optical power of the complementary color. For example, in an RGB-LED background light source, if the color of the shadow is magenta, the optical power of the complementary color, namely green, is increased. By adding green LEDS in the RGB-LED background light source and driving these green LEDs under appropriate electrical conditions, the optical power of the green light is increased in a quantity appropriate to neutralize the colored shadow. This results in an RGB-LED background light source comprising a greater number of green LEDs with respect to the number of red and blue LEDs.

Alternatively, if the color of the shadow is green, the optical power of the complementary color, namely magenta, is increased. Magenta is obtained by combining two primary colors, namely red and blue. By providing the RGB-LED white light source with additional red and blue LEDs, the colored shadow is neutralized.

In a background light LED source comprising white LEDs or using blue and yellow LEDs to create white light, if the color of the shadow is magenta, the optical power of the complementary color, namely green, is increased. By adding green LEDs in the background LED light source, the colored shadow is neutralized.

In one embodiment of the method, the increase of the optical power of the spectral component corresponding to the complementary color is substantially equal to the optical power of the spectral component corresponding to the color of the shadow. The color of the shadow and its complementary color are then present in substantially even proportions in order to neutralize the colored shadow.

In one embodiment of the method 10, a colored shadow is observed when an object is illuminated by a colored focusing light source while the region surrounding the shadow is illuminated by a background white light. The needed color is the color of the shadow and the optical power of the color of the shadow is increased, in the focusing light source, in a quantity appropriate to reduce or substantially eliminate the colored shadow.

If the focusing light source is an LED lighting device and if the color of the shadow can be achieved using the colored LEDs present in the focusing light source, then the LEDs which emit, alone or in combination, light of the color of the shadow are driven under appropriate electrical conditions to substantially eliminate the colored shadow.

If the focusing light is a non-LED lighting device or if the color of the shadow cannot be achieved using the LEDs present in the focusing light source, at least one LED emitting light of the color of the shadow is added in the focusing lighting device and driven under appropriate electrical conditions. Alternatively, one can add, in the focusing light, at least two LEDs emitting light of different colors of which the mixing results in the color of the shadow.

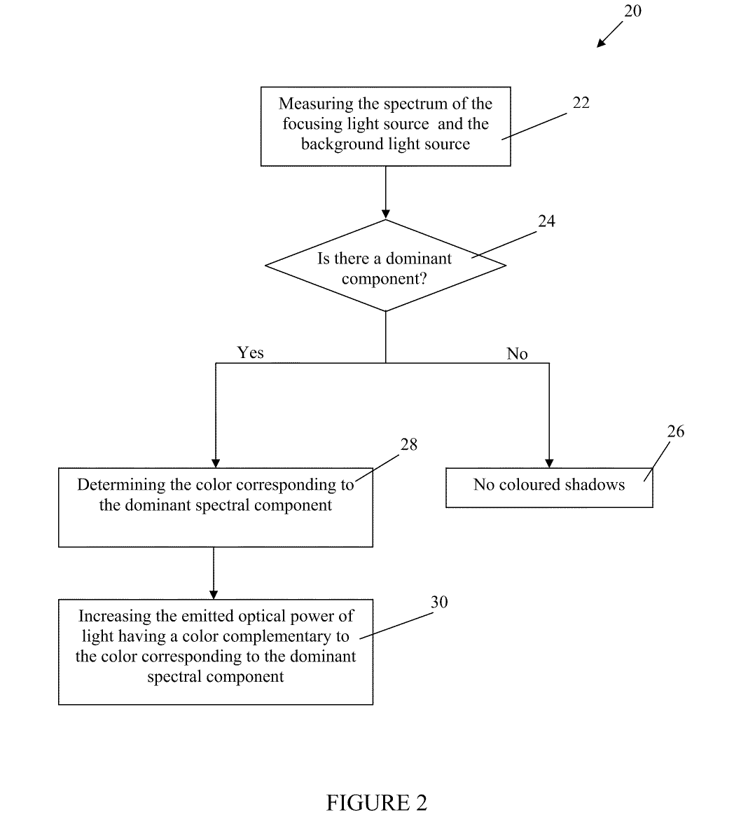

FIG. 2 illustrates one embodiment of a method 20 for avoiding colored shadows in an environment where an object is illuminated by a focusing light source and a background light source.

The first step 22 of the method is the measurement of the spectrum of the background light source and the focusing light source. This can be done experimentally. It should be understood that any technique to measure the spectrum of a light source known to a person skilled in the art can be used. Alternatively, one can use the specification sheets provided by the manufacturer of the background light and the focusing light source.

The second step 24 is the determination of a dominant component in the spectrums. If no dominant component is detected in the spectrum of the background light source and the focusing light source, the risk of having a colored shadow is avoided 26. If a dominant component is detected in the spectrum of the background light source and/or the focusing light source, the next step 28 is the determination of the color corresponding to the spectral component. The risk of having a colored shadow can be averted by increasing, in the background light source and/or the focusing light source, the optical power of the color complementary to the color corresponding to the dominant spectral component 30 in an appropriate quantity such that light of the complementary color and light of the color corresponding to the dominant component are emitted in a substantially even proportion by the background light source and/or the focusing light source.

In one embodiment where the background light source and/or the focusing light source creates light using colored LEDs, and where light of the complementary color can be achieved using these colored LEDs, the increase of the optical power of light having the complementary color can be achieved by driving at least one LED emitting the complementary color under higher electrical conditions. Alternatively, at least one LED emitting the complementary color can be added in the background light source and/or the focusing light source.

In another embodiment, where the background light source and/or the focusing light source is not an LED lighting device or where the complementary color cannot be achieved using the LEDs present in the background light source and/or the focusing light source, at least one LED emitting the needed color is added to the background light source and/or the focusing light source.

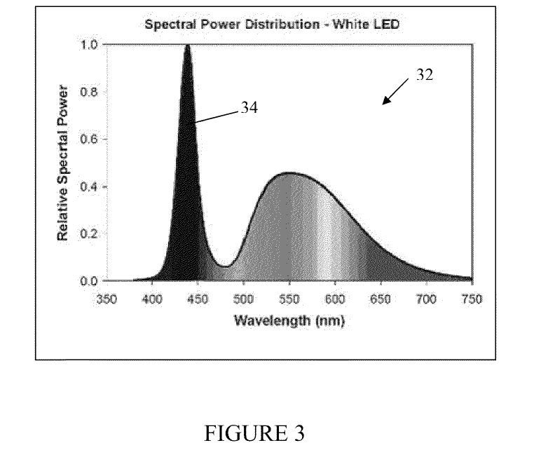

FIG. 3 illustrates an example of a spectrum 32 of a light having a dominant spectral component 34. The spectrum has a peak around 445 nm which corresponds to blue light. If this light is used as a focusing light source and illuminates an object in the presence of a background white light, the shadow of the object will appear yellow. If the focusing light source comprises yellow LEDs or green and red LEDs, the yellow shadow can be avoided by driving the yellow LEDs of the green and red LEDs under higher electrical conditions than the other LEDs in the focusing light source. Alternatively, yellow LEDs or green and red LEDs can be added in the focusing light source.

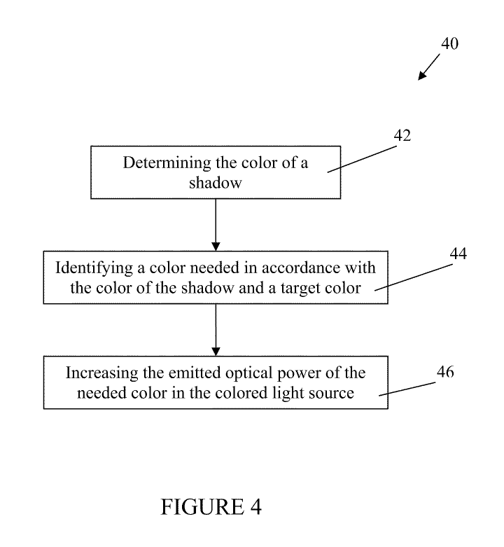

FIG. 4 illustrates one embodiment of a method 40 of modifying the color of a shadow created by a focusing light source and a background light source in order to obtain a shadow having a target color. The first step 42 of the method 40 is the determination of the color of the shadow. The second step 44 is the determination of the color needed to obtain a target color for the colored shadow in accordance with the actual color of the shadow and the target color. The last step 46 of the method consists in increasing the optical power of light having the needed color in the colored light.

In one embodiment, the colored light source is the background light source and the focusing light source is a white light source. In this case, the needed color is a color that when combined with the color of the shadow will result in the target color. The optical power of the light having the needed color is increased in the background light source.

For example, the actual color of the colored shadow is yellow and the target color is red. The shadow appears yellow because the focusing light source emits more blue light than other colored light. In order to color the shadow red, the focusing light source should emit more cyan light than other colored light. By increasing the optical power of the green light in the focusing light source, the light emitted by this focusing light emits more cyan light than other colored lights since green light and blue light mix to give cyan light. Therefore, by increasing the optical power of the green light in the focusing light source, in an appropriate quantity, the color of the shadow passes from yellow to red.

In another embodiment, the colored light source is the focusing light source and the background light source is a white light source. In this case, the needed color is a color that when combined with the color complementary to the color of the shadow will result in the color complementary to the target color. The optical power of the light having the needed color is increased in the focusing light source.

For example, if the shadow appears green and the target color is red, a combination of magenta light and red light is added. The magenta light neutralizes the green shadow and the red light colors the shadow red. Magenta light can be created by mixing light emitted by red and blue LEDs. If the background light source comprises red and blue LEDS, driving the red and blue LEDs under higher electrical conditions than the remaining LEDs in the background light source colors the shadow red. The red LEDs are driven under higher electrical conditions than the blue LEDs. Alternatively, red and blue LEDs can be added in the background light source. The number of red LEDs added to the source is superior to that of the blue LEDs so that the resulting color of the light emitted by the added red and blue LEDs corresponds to the combination of magenta and red.

If the shadow appears green and the target color is yellow, red light is added in the background light source in order to color the shadow yellow, since mixing green light and red light results in yellow light. In the background light source, the optical power of the red light is increased. This can be done by driving the red LEDs under higher electrical conditions than the remaining LEDs if the background light source comprises red LEDs. Alternatively, red LEDs can be added in the background light source.

If the shadow appears green and the target color is magenta, magenta light is added in order to color the shadow magenta. By sufficiently increasing the optical power of the magenta light in the background light source, the shadow is neutralized since green and magenta are complementary colors. By further increasing the optical power of the magenta light in the background light source, the shadow appears magenta. Magenta light can be achieved by mixing red and blue light. If the background light source comprises red and blue LEDs, driving the red and blue LEDs under higher electrical conditions colors the shadow magenta. Alternatively, red and blue LEDs can be added in the background light source.

In a further embodiment, the color of the shadow can be changed in two steps. The first step consists in neutralizing the colored shadow using one of the background light source and the focusing light source and the second step consists in coloring the shadow the target color using the other one of the background light source and the focusing light source. A first needed color is then determined to neutralize the colored shadow and a second needed color is determined to color the shadow as the target color.

In one embodiment, the colored light source causing the colored shadow is the background light source and the focusing light source is a white light source. In this case, the first needed color is the complementary color of the color of the shadow and the optical power of light of this first needed color is increased in the background focusing light source in order to neutralize the colored shadow. The second needed color is the complementary color of the target color and the optical power of light of this second needed color is increased in the focusing light source.

In another embodiment, the colored light source is the focusing light source and the background light source is a white light source. In this case, the first needed color is the color of the shadow and the optical power of light having the color of the shadow is increased in the focusing light source in order to neutralize the colored shadow. The second needed color is the target color and the optical power of light of the target color is increased in the background light source in an appropriate quantity to color the shadow the target color.

In one embodiment, no colored shadow is created when an object is illuminated by a focusing light source and a background light source. This can be the case when the focusing light and the background illumination light have the same spectrum. Alternatively, no colored shadow appears if both the focusing light source and the background light source are neutral white light sources. When no colored shadow exists, the shadow can be colored a target color by increasing the optical power of light having the target color in the background light source or increasing the optical power of light having the color complementary to the target color in the focusing light source.

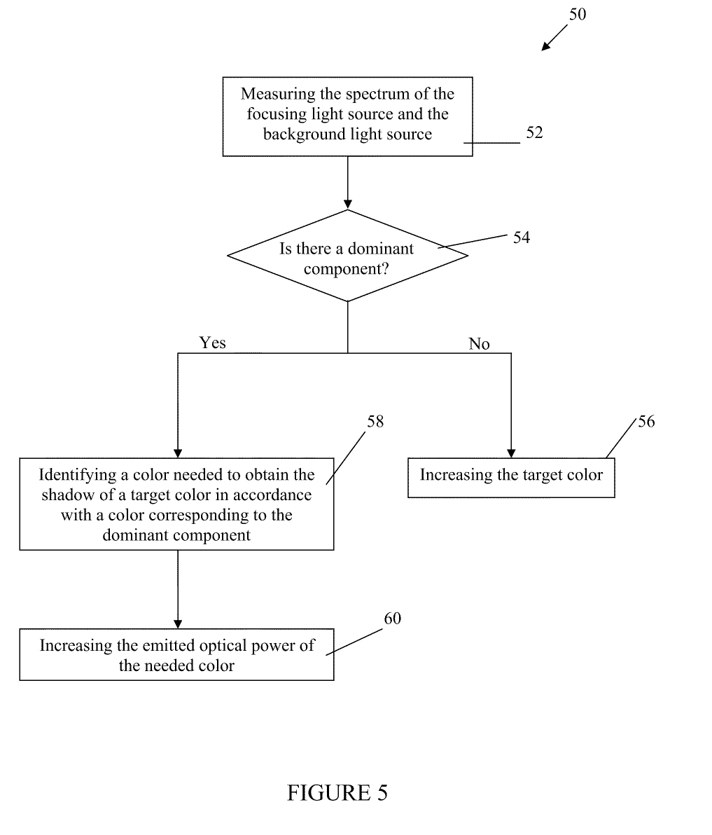

FIG. 5 illustrates one embodiment of a method 50 for coloring a shadow of an object illuminated by a focusing light source in the presence of a background light source. The first step 52 of the method is the measurement of the spectrum of the focusing light source and the background light source. The second step 54 is the determination of a dominant component in the spectrum of the focusing light source and the background light source.

If no dominant component is detected in the spectrums, the next step 56 is the increase of the optical power of light of the target color light in the background light source to obtain a shadow of the target color. Alternatively, the optical power of light having a color complementary to the target color can be increased in the focusing light source. The increase of the optical power can be performed either by driving LEDs under higher electrical conditions or by adding LEDs.

If a dominant component is detected in one of the spectrums, the next step 58 is the identification of a color needed to obtain the shadow of a target color in accordance with a color corresponding to the dominant component. If the dominant component is detected in the spectrum of the background light source, the needed color is a color that when combined with the color corresponding to the dominant spectrum results in the target color. If the dominant spectrum is observed in the spectrum of the focusing light source, the needed color is a color that when combined with the color corresponding to the dominant spectrum results in the complementary color of the target color.

The last step 60 of the method consists in increasing of the optical power of the light of the needed color in the corresponding light source. If the dominant component is detected in the spectrum of the background light source, the optical power of light of the needed color is increased in the background light source. If the dominant spectrum is observed in the spectrum of the focusing light source, the optical power of light of the needed color is increased in the focusing light source.

The different methods illustrated above can be embodied in a system comprising a focusing light source and a background light source. The focusing light source is used to illuminate an object and create a shadow of the object. The background light source is used to illuminate the shadow and the region surrounding the shadow.

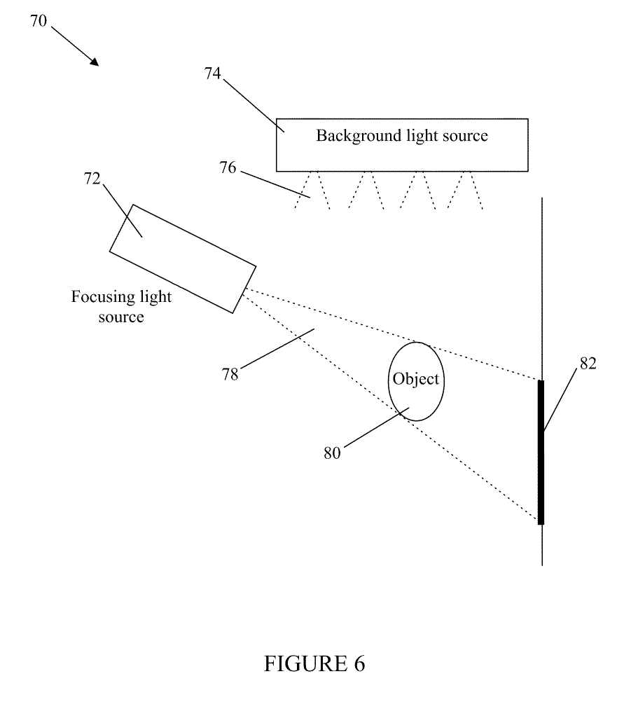

For example, FIG. 6 illustrates one embodiment of a lighting system 70 comprising a focusing light source 72 and a background light source 74. The beams of light 76 coming from the background light source 74 are used as background illumination. The beam of light 78 emitted by the focusing light source 72 is directed towards an object 80 in order to highlight the object 80. The object 80 blocks part of the beam 78 and creates a shadow 82 behind the object 80. The background light source 74 illuminates the region which comprises the shadow 82 of the object 80.

In one embodiment, if the spectrum of the focusing light source 72 has a dominant spectral component and if the background light source 74 is a neutral white light source, the shadow 82 will appear colored. In order to substantially eliminate the colored shadow 82, the focusing light source 72 is provided with an increased output power of the color complementary to the color corresponding to the dominant spectral component.

It should be noted that it is possible to vary the emitted wavelength of the LED by varying the electrical conditions or the temperature since the emitted wavelength of an LED is dependant on parameters such as temperature or electrical conditions. For example, a red LED emits red light under normal electrical conditions but emits a substantially magenta light when driven under low electrical conditions. In one embodiment, the optical power of magenta light is increased in order to color a shadow or neutralize a colored shadow. Instead of adding LEDs for which the combination results in magenta light, red LEDs can be added to the white light LED source and the added red LEDs are driven under specific conditions so that the added red LEDs emit magenta light.

In one embodiment, in order to increase the optical power of light of a desired color, at least one LED emitting light having the desired color can be added and/or driven under specific electrical conditions in order to either neutralize or color a shadow.

In one embodiment, a desired color to be added in a light source is achieved by combining colored LEDs emitting different colored lights and adjusting the proportion of the different colored lights in order to achieve the desired color. For example, if yellow is to be added, green and red LEDs can be added in the white light LED source. The green and red light emitted by the green and red LEDS, respectively, are provided in substantially even proportions. This is achieved by providing the same optical power of green light and red light. Using the same green and red LEDs, other colors can be achieved by varying the proportions of green and red emitted lights. For example, orange is achieved by providing more optical power of red light than green light.

It should be noted that it may be possible to combine at least two LEDs of different colors in order to obtain light having a desired color.

In one embodiment, LEDs from different groups of LEDs emitting different colored lights can be added and/or driven under specific electrical conditions to achieve light having a desired color and optical power. Each group of LEDs includes at least one LED.

It should also be understood that the focusing light source and the background light source can be LED light sources or non-LED lighting sources. For example, they can be a gas discharge lamp, an incandescent lamp, an HID lamp, a low pressure sodium lamp or a fluorescent lighting source. In these cases, an increase of optical power of a desired colored light is performed by adding at least one LED emitting the desired color in the non-LED lighting device. Alternatively, the focusing light source and the background light source can be LED lighting devices comprising white LEDs and/or colored LEDS.

When at least one LED is added in a light source, additional optics may be used to mix the light emitted by the LED and the light source.

In addition, when providing a needed color in a white light LED source, it should be provided in an appropriate quantity to modify/create/eliminate the colored shadow. Too much of an added color will not produce the desired color. Similarly, not enough of the added color will also fail to produce the desired effect.

It should be understood that the present invention can be embodied in a method or a system. The embodiments of the invention described above are intended to be exemplary only. The scope of the invention is therefore intended to be limited solely by the scope of the appended claims.

1. A method for modifying a color of a shadow resulting from the interaction of a white light source and a colored light source illuminating an object, said method comprising:
identifying a color of said shadow;
determining a needed color, as a function of said color of said shadow, to modify said color of said shadow to a target color; and
providing said needed color in said colored light source in a quantity appropriate to modify said color of said shadow to said target color.

2. A method as claimed in claim 1, wherein said determining a needed color comprises determining a first needed color to neutralize a color of said shadow, and determining a second needed color to create a shadow of said target color.

3. A method as claimed in claim 2, wherein said providing said needed color comprises providing a complementary color of said color of said shadow in said colored light source to neutralize said color of said shadow, and providing said target color in said colored light source to create said shadow of said target color.

4. A method as claimed in claim 2, wherein said providing said needed color comprises providing said color of said shadow in said colored light source to neutralize said color of said shadow, and providing a complementary color of said target color in said colored light source to create said shadow of said target color.

5. A method as claimed in claim 1, wherein said providing said needed color comprises providing a complementary color of said color of said shadow in said colored light source to modify said color of said shadow to a neutral color.

6. A method as claimed in claim 1, wherein said providing said needed color comprises providing said color of said shadow in said colored light source to modify said color of said shadow to a neutral color.

7. A method as claimed in claim 1, wherein said identifying a color of said shadow comprises measuring a spectrum of said colored light source and identifying a dominant spectral component therein, said color of said shadow corresponding to said dominant spectral component.

8. A method as claimed in claim 1, wherein said providing said needed color comprises increasing an electrical condition under which an LED of said needed color in said colored light source is driven.

9. A method as claimed in claim 8, wherein said increasing said electrical condition comprises increasing an electrical condition under which a first LED of a first color and a second LED of a second color are driven, said first color and said second color resulting in said needed color when mixed together.

10. A method as claimed in claim 1, wherein said providing the needed color comprises adding an LED of said needed color to said colored light source.

11. A method as claimed in claim 10, wherein said adding said LED of said needed color comprises adding a first LED of a first color and a second LED of a second color, said first color and said second color resulting in said needed color when mixed together.

12. A lighting system for illumination of an object, comprising:
a focusing light source for illuminating said object and creating a shadow of said object; and
a background light source for illuminating a region comprising said shadow; and
at least one LED emitting light, in one of said focusing light and said background light, of a given color in an appropriate quantity to color said shadow a target color.

13. The lighting system as claimed in claim 12, wherein said focusing light source has a dominant spectral component, said background light source is a substantially neutral white light source, and said at least one LED is positioned in said focusing light source, said given color is a combination of a complimentary color of a color corresponding to said dominant spectral component and a complimentary color of said target color.

14. The lighting system as claimed in claim 12, wherein said background light source has a dominant spectral component, said focusing light source is a substantially neutral white light source, and said at least one LED is positioned in said background light source, said given color is a combination of a color corresponding to the dominant spectral component and the target color.

15. The lighting system as claimed in claim 12, wherein said focusing light source and said background light source are substantially neutral white light sources.

16. The lighting system as claimed in claim 15, wherein said at least one LED is positioned in said background light source and said given color is said target color.

17. The lighting system as claimed in claim 15, wherein said at least one LED is positioned in said focusing light source and said given color is a complementary color of said target color.

18. The lighting system as claimed in claim 12, wherein said background light source is an LED light source.

19. The lighting system as claimed in claim 12, wherein said focusing light source is an LED light source.

20. (canceled)

21. (canceled)

22. (canceled)

23. The lighting system as claimed in claim 12, wherein said at least one LED emitting light of said given color comprises a plurality of LEDs of different colors, said different colors resulting in said given color when mixed together.
